(19) United States
(12) Patent Application Publication
(10) Pub. No.: US 2025/0244716 A1
(43) Pub. Date: Jul. 31, 2025

(54) REGULATING MEMBER FOR A WATCH MOVEMENT

(71) Applicant: CHRONODE SA, Le Locle (CH)

(72) Inventors: Jean-François MOJON, Les Hauts-Geneveys (CH); Xavier CLEMENT, Fournets Luisans (FR); Sébastien DORDOR, Versoix (CH)

(73) Assignee: CHRONODE SA, Le Locle (CH)

(21) Appl. No.: 18/862,465

(22) PCT Filed: May 2, 2023
(86) PCT No.: PCT/IB2023/054547

§ 371 Date: Nov. 1, 2024

(30) Foreign Application Priority Data
May 3, 2022 (CH) 000514/2022
May 3, 2022 (EP) 22171307.6

(51) Int. Cl. G04B 17/26

(52) U.S. Cl. CPC G04B 17/26

(57) ABSTRACT

A regulating device for a watch movement has an oscillator including at least a first and a second balance. Each balance has an inertia wheel and a balance staff. The oscillator includes at least one elastic member intended to maintain the oscillations of the oscillator. The latter also has a gear train comprising at least two mobiles. The inertia wheel of each balance is fixed in rotation to a mobile of the gear train. The gear train connects the inertia wheels of the first and second balance by a desmodromic link so that the respective oscillations of the first and second balances are in phase opposition. The regulating member further has an escapement including at least one escapement wheel and at least one anchor intended to regulate the at least one escapement wheel and to maintain the oscillations of the oscillator. A method of adjusting the frequency of the oscillator of the regulating member.

### TECHNICAL FIELD

The present invention relates to a regulating member for a watch movement. The invention also relates to a watch movement comprising the regulating member and to a timepiece comprising such a movement.

### STATE OF THE ART

In general, mechanical watches include a watch movement whose oscillation frequency of the regulating member varies between 3 Hz and 5 Hz. This oscillation frequency can, however, go beyond 5 Hz in order to increase the precision of the watch. That said, a low-frequency regulating member can provide several advantages, including an increase in the power reserve and simplification of the watch movement.

Low-frequency regulating members are already known from the state of the art.

By way of example, CH75063 discloses an escapement having a reversing wheel arranged to impart the impulse to the balance via a gear in order to reduce the number of oscillations of the balance so that the latter oscillates at a frequency of 0.5 H.

In order to maintain an acceptable quality factor for a low-frequency regulating member, the inertia of the balance must be increased compared with a mechanical movement equipped with a higher-frequency oscillator. This increase in inertia has the main disadvantage of increasing sensitivity to angular accelerations.

An aim of the present invention is therefore to provide a regulating member which eliminates, or at least reduces, sensitivity to angular accelerations.

Another aim of the present invention is to provide a simplified watch movement comprising a low-frequency regulating member.

An additional aim of the present invention is to provide a method of adjusting the frequency of the oscillator of the regulating member.

### BRIEF SUMMARY OF THE INVENTION

These aims are achieved in particular by a regulating member for a watch movement. The regulating member comprises an oscillator including at least a first and a second balance. Each balance comprises an inertia wheel and a balance staff. The oscillator comprises at least one elastic member intended to maintain its oscillations. This oscillator further comprises a gear train comprising at least two mobiles. The inertia wheel of each balance is fixed in rotation to a mobile of the gear train. The gear train is arranged to connect the inertia wheel of the first and second balances together by a desmodromic link so that the respective oscillations of the first and second balances are in phase opposition. The regulating member further includes an escapement comprising at least one escapement wheel and at least one anchor intended to regulate said at least one escapement wheel and to maintain the oscillations of the oscillator.

In one embodiment, the regulating member comprises at least three balances, each comprising an inertia wheel. The respective oscillations of two balances following each other in the kinematic chain of the at least three balances are in phase opposition.

In one embodiment, the gear train comprises more than two mobiles.

In one embodiment, the balance staffs of the first and second balances are coaxial.

In one embodiment, the balance staffs of the first and second balances are parallel, while their respective inertia wheels are arranged to oscillate in two parallel planes.

In one embodiment, the inertia wheels of the first and second balances lie substantially in the same plane.

In one embodiment, the balance staffs of the first and second balances are contained within intersecting planes.

In one embodiment, the inertia wheel of each of the first and second balances comprises a plurality of disjoint rim segments, for example two, three or even four rim segments, together forming the rim of each inertia wheel along respective circles. These circles respectively define a first and a second disc that intersect or overlap to form an overlapping zone or an intersection zone.

In one embodiment, the overlapping zone is in the form of a lens. This lens is preferably a symmetrical lens.

In one embodiment, the intersection zone is a straight-line segment.

In one embodiment, at least one of the first and second balances does not comprise said at least one elastic member.

In one embodiment, at least one elastic member is mounted on an intermediate mobile of the gear train. The inertia of the intermediate mobile is at least five times, preferably at least ten times, or even at least twenty times less than the inertia of any of the balances of the oscillator.

In one embodiment, at least one of the first and second balances and/or an

intermediate mobile of the gear train comprises an even number, preferably two, of elastic members wound in opposite directions.

In one embodiment, the escapement comprises only one anchor arranged to cooperate with one of the first and second balances and the escapement wheel.

In one embodiment, the escapement comprises two anchors arranged to cooperate, on the one hand, with the first and second balances respectively and, on the other hand, with a single escapement wheel, or with a first and second escapement wheel respectively.

In one embodiment, the escapement comprises a first and a second half-anchor arranged to cooperate with the first and second balances respectively. The first and second half-anchors comprise respectively a first pallet and a second pallet arranged to cooperate with a single escapement wheel or with respectively a first and a second escapement wheel.

In one embodiment, the escapement comprises an anchor arranged to cooperate with one of the first and second balances. The anchor comprises a first pallet arranged to cooperate with a first escapement wheel and a second pallet arranged to cooperate with a second escapement wheel.

In one embodiment, the escapement comprises an anchor arranged to cooperate with an intermediate mobile of the gear train and an escapement wheel.

Another aspect of the invention relates to a method for setting the frequency of the oscillator of the regulating member. The method consists in determining, firstly, the inertia of all the balances and the return torque of said at least one elastic member of the oscillator. This method further consists, secondly, in replacing at least one of the mobiles of the gear train, preferably an intermediate mobile, by a mobile with a different inertia so as to obtain a ratio between the inertia of all the balances and the return torque of said at least one elastic member defined by the desired frequency of the oscillator.

Another aspect of the invention relates to a method of setting the frequency of the oscillator of the regulating member according to an alternative solution. According to this alternative, the method consists in determining, firstly, the inertia of all the balances and the return torque of said at least one elastic member. This method also consists, secondly, in replacing at least one of the mobiles of the gear train, preferably an intermediate mobile, with a mobile having a pitch diameter different from that of the mobile replaced, so as to obtain a ratio between the inertia of all the balances and the return torque of said at least one elastic member defined by the desired frequency of the oscillator.

Another aspect of the invention relates to a method of setting a watch movement comprising a driving source, in particular a barrel, and the regulating member. The method consists in determining, firstly, the torque supplied by the driving source to the escapement wheel, the inertia of all the balances of the oscillator and the return torque of the at least one elastic member. This method further consists in replacing, secondly, at least one mobile of the gear train, preferably an intermediate mobile, with a mobile having a different inertia and/or a different pitch diameter so as to obtain a defined ratio between the inertia of all the balances of the oscillator and the return torque of said at least one elastic member, as well as a defined ratio between the power required to maintain the oscillations of the oscillator and the power available to the escapement wheel.

### BRIEF DESCRIPTION OF THE FIGURES

Examples of embodiments of the invention are described in the description illustrated by the appended figures in which:

FIG. 1 depicts a schematic top view of a simplified watch movement according to one embodiment of the invention;

FIG. 2 depicts a perspective view of an oscillator comprising two hairspring-balances driven together by a desmodromic gear train according to one embodiment of the invention;

FIG. 3 depicts a top view of FIG. 2;

FIG. 4 depicts a view similar to FIG. 3 without the hairsprings;

FIG. 5 depicts a side view of FIG. 2,

FIG. 6 depicts a perspective view of an oscillator according to another embodiment of the invention;

FIG. 7 depicts a top view of FIG. 6;

FIG. 8 depicts a side view of FIG. 6;

FIG. 9 depicts a perspective view of the regulating member comprising two hairspring-balances driven together by a desmodromic gear train according to another embodiment of the invention,

FIG. 10 depicts a side view of FIG. 9,

FIG. 11 depicts a schematic top view of a regulating member according to one embodiment,

FIG. 12 is a schematic top view of a regulating member according to another embodiment,

FIG. 13 depicts a schematic top view of a regulating member according to another embodiment,

FIG. 14 depicts a schematic top view of a regulating member according to another embodiment,

FIG. 15 depicts a schematic top view of a regulating member according to another embodiment,

FIG. 16 depicts a schematic top view of a regulating member according to another embodiment,

FIG. 17 depicts a schematic top view of a regulating member according to another embodiment,

FIG. 18 depicts a schematic top view of a regulating member according to another embodiment,

FIG. 19 depicts a schematic top view of a regulating member according to another embodiment,

FIG. 20 depicts a schematic top view of a regulating member according to another embodiment,

FIG. 21 depicts a schematic top view of a regulating member according to another embodiment,

FIG. 22 depicts a schematic top view of a regulating member according to another embodiment,

FIG. 23 depicts a schematic top view of a regulating member according to another embodiment,

FIG. 24 depicts a schematic top view of a regulating member according to another embodiment,

FIG. 25a depicts a top view of an escapement of the regulating member of FIG. 12,

FIG. 25b depicts a top view of an escapement, according to another embodiment, of the regulating member of FIG. 12,

FIG. 25c depicts a top view of an escapement, according to another embodiment, of the regulating member of FIG. 12,

FIG. 25d depicts a view at the point of contact between a pallet of one of the anchors in FIG. 25c and a tooth of the escapement wheel,

FIG. 26 depicts a top view of an escapement of the regulating member of FIG. 17,

FIG. 27 depicts a schematic top view of the oscillator according to another embodiment,

FIG. 28 depicts a schematic top view of the oscillator illustrating an overlapping zone between two balances according to another embodiment,

FIG. 29 depicts a schematic top view of the oscillator illustrating an overlapping zone between two balances according to another embodiment, and

FIG. 30 depicts a schematic view of the oscillator illustrating two intersection zones between three balances according to another embodiment.

### EXAMPLES OF EMBODIMENTS OF THE INVENTION

In the present application, “oscillator” shall be understood to mean a resonator comprising, on the one hand, a plurality of balances and, on the other hand, a gear train arranged to be engaged with the balances so as to make the latter dependent on one another. In addition, in the present application, “regulating member” shall be understood to mean an assembly comprising the oscillator and a counting organ, in particular an escapement.

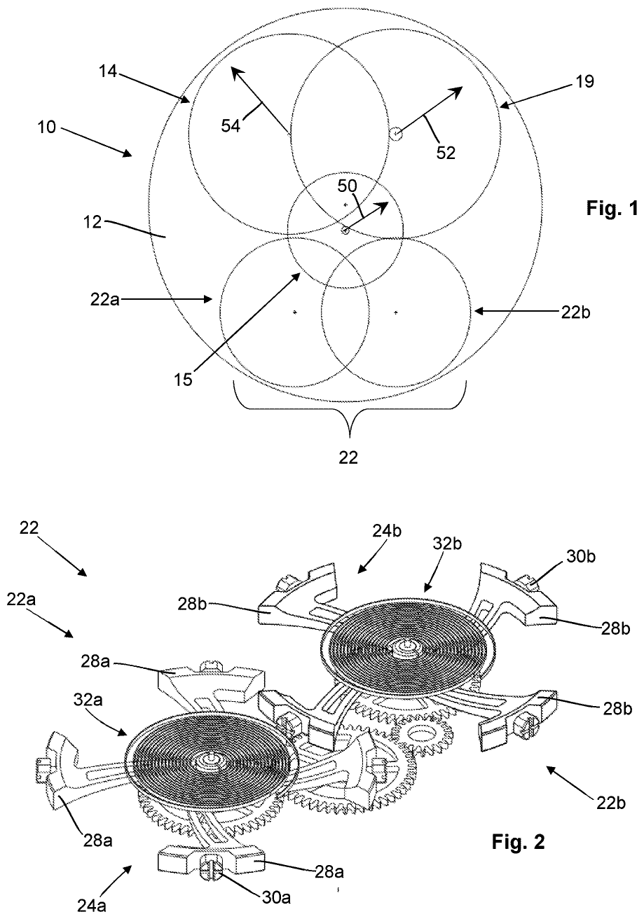

With reference to FIG. 1, the watch movement 10 has a simplified construction thanks to a low-frequency regulating member with a double hairspring-balances 22a, 22b, which will be described later, configured to oscillate at a frequency of less than 1.5 Hz. Depending on the inertia of the balances selected, the power reserve can be considerably increased, particularly if high chronometric performance is not a priority.

The simplified watch movement comprises a plate 12 on which are mounted a barrel 14, an escapement 15 comprising an escapement wheel and a kinematic link connecting the barrel 14 to the pinion of the escapement wheel. The kinematic link comprises fewer than three mobiles.

According to an advantageous embodiment, this kinematic link comprises only one mobile 19 meshing on the one hand with the ratchet of the barrel 14 and, on the other hand, with the pinion of the escapement wheel. The mobile 19 therefore replaces the centre wheel, the third wheel and the seconds wheel of a conventional movement.

According to a non-illustrated variant, the kinematic link comprises no less and no more than two mobiles meshing together. One of the two mobiles is engaged with the barrel ratchet while the other of the two mobiles is engaged with the pinion of the escapement wheel.

The simplified watch movement has the advantage of providing a new architecture with possibilities for identifying the unique product due to the fact that the geometric constraints, for example the centre distances, are very different from traditional movements. In addition, simplifying the movement increases overall efficiency by reducing the number of gears.

Under certain conditions linked to the gear ratios and the escapement, it is possible to display the seconds directly on the escapement wheel. In this case, the gear ratios between the barrel 14, the mobile 19 and the pinion of the escapement wheel 16 are chosen so that the latter can make one complete rotation per minute. A second indicator 50 may be mounted on the shaft of the escapement wheel.

Similarly, under certain conditions linked to the gear ratios, the mobile 19 can directly display the minutes. The gear ratio between the barrel and the mobile 19 is therefore chosen so that the latter can make one complete rotation per hour. A minute indicator 52 may, for example, be mounted on the shaft of the mobile 19.

Finally, under certain conditions linked to the gear ratios, the barrel 14 can display the hour. For example, an hour indicator 54 may be mounted on the shaft of barrel 14.

As mentioned previously, a simplified watch movement can only be produced by using a low-frequency regulating member. In order to maintain an acceptable quality factor, the inertia of the balance must be increased compared with a mechanical movement equipped with a higher-frequency oscillator. This increase in inertia has the main disadvantage of increasing sensitivity to angular accelerations. In order to counteract this sensitivity to acceleration, the oscillator of the regulating member comprises at least two balances coupled in phase opposition in different ways, i.e. a hairspring is associated with each of the two balances so that one of the hairsprings is in a contraction phase while the other of the hairsprings is in an expansion phase. Alternatively, phase opposition can be achieved by mounting on one of the balances of the oscillator two hairsprings wound in opposite directions so that one of the two hairsprings is in a contraction phase when the other of the two hairsprings is in an expansion phase.

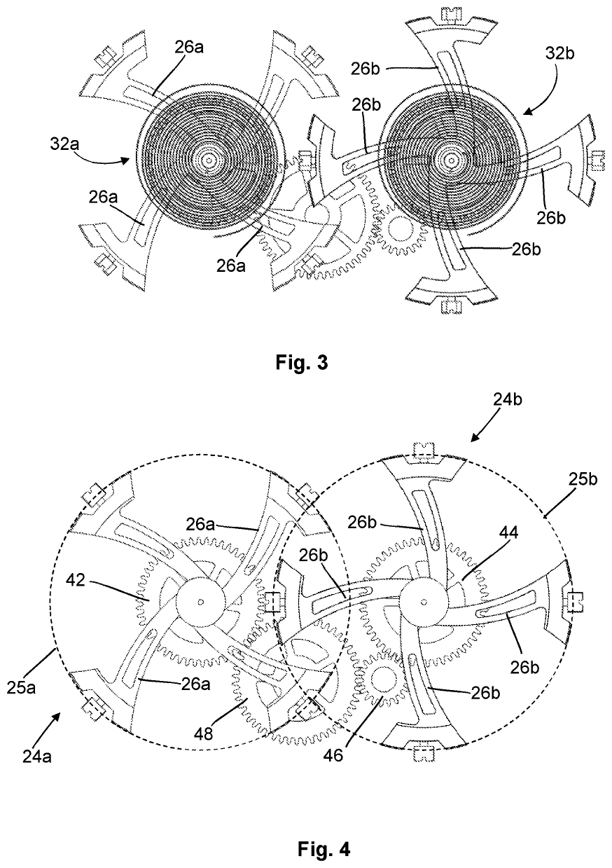

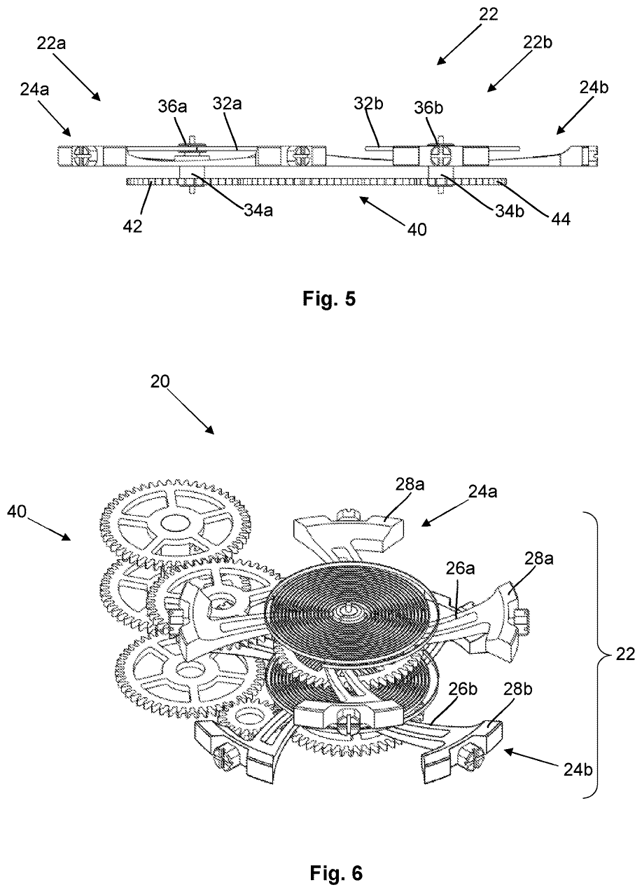

According to an advantageous embodiment, illustrated by FIGS. 2 to 5, the oscillator 22 comprises a first and a second hairspring-balance 22a, 22b arranged in the same plane. Each hairspring-balance 22a, 22b comprises an inertia wheel 24a, 24b, a hairspring 32a, 32b and a balance staff 34a, 34b. The inertia wheel comprises rim segments 28a, 28b and balance arms 26a, 26b connecting the rim segments to the balance staff. One end of each hairspring 32a, 32b is connected to the respective balance staff by means, for example, of a collet 36a, 36b (FIG. 5) driven onto the balance staff, while the other end is connected, for example, to a stud mounted on a stud-holder which is itself connected to a bridge or fixed cock (not illustrated) relative to the plate 12 of the watch movement 10.

The oscillator may comprise an elastic member other than a conventional flat hairspring, for example a cylindrical hairspring, a hemispherical or spherical hairspring or a conical hairspring. Alternatively, the spiral may comprise a plurality of turns. The oscillator may also comprise an elastic member not similar to a hairspring to fulfil the function of returning the balance.

The first and second hairspring-balances 22a, 22b of the oscillator 22 are connected by a gear train 40 in order to drive these hairspring-balances by a desmodromic link so that the inertia wheel 24a of one of the two hairspring-balances 22a, 22b can oscillate in phase opposition with respect to the inertia wheel 24b of the other of the two hairspring-balances. In other words, the hairspring 32a of one of the two balances 22a, 22b is in an expansion phase while the hairspring 32b of the other of the two balances 22a, 22b is in a contraction phase, which has the effect of driving the respective inertia wheels 24a, 24b in opposite directions. This particular arrangement of the two hairsprings 32a, 32b allows the sensitivity of the oscillator 22 to angular accelerations to be cancelled out or at least reduced.

As can be seen in particular in FIGS. 4 and 5, the gear train 40, ensuring the desmodromic link between the two hairspring-balances 22a, 22b, comprises a first mobile 42 connected to the staff 34a of the balance of one of the two hairspring-balances 22a, 22b, a second mobile 44 connected to the staff 34b of the balance of the other of the two hairspring-balances 22a, 22b and two intermediate mobiles 46, 48 in mesh respectively with the first and second mobiles 42, 44. The ratios and the number of gears have been determined so that the first and second inertia wheels 24a, 24b of the respective hairspring-balances 22a, 22b can oscillate in phase opposition.

With reference in particular to FIG. 2, the inertia wheel 24a, 24b of each hairspring-balance 22a, 22b comprises four arms 26a, 26b separated from each other by an angle of 90°. Each arm 26a, 26b extends from the respective balance staff 34a, 34b in a radial direction to a distal portion 28a, 28b. Furthermore, the thickness of each arm 26a, 26b increases from the balance staff to the corresponding distal portion.

The distal portions of the first and second inertia wheels 24a, 24b each form four disjoint rim segments 28a, 28b along a first and second circle 25a, 25b respectively, as shown in FIG. 4. Each of the four disjoint rim segments 28a, 28b of each balance 22a, 22b extends along an arc of a circle of between 20° and 50°, for example, and preferably along an arc of a circle of between 30° and 40°.

According to other variants, the inertia wheel of each hairspring-balance may comprise only two or three arms. In this case, the rim segment associated with each arm will be larger so that the inertia of each balance remains constant. For example, each discontinuous rim segment of the inertia wheel may extend along an arc of a circle greater than 45° in the case where each balance has three arms, or even greater than 60° in the case where each balance has only two arms.

A weight 30a, 30b in the form of screws are screwed into each rim segment 28a, 28b, for example in a radial direction, in order to be able to modify the inertia of the inertia wheel 24a, 24b of each hairspring-balance in order to adjust their oscillation frequency.

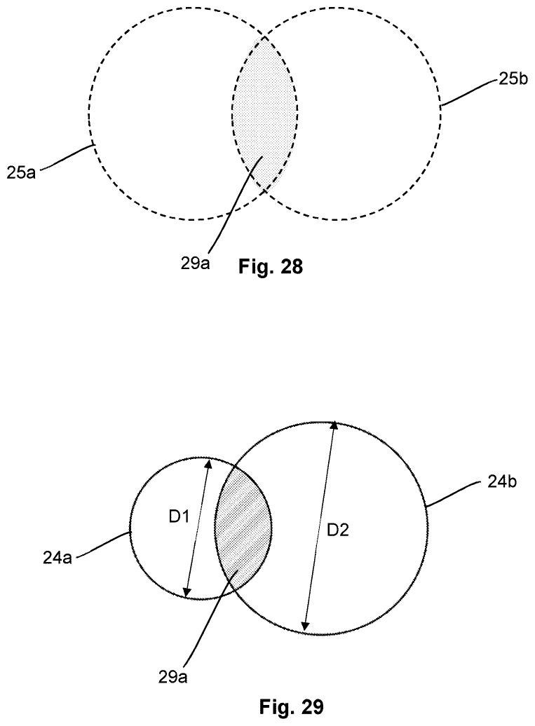

The centre distance between the two balance staffs 34a, 34b of the first and second hairspring-balances 22a, 22b respectively is reduced so as to limit the variations in the influence of the acceleration between the first and second inertia wheel 24a, 24b. According to this configuration, the first and second circles 25a, 25b, along which the disjoint rim segments 28a, 28b of the first and second inertia wheels 24a, 24b respectively are arranged, intersect. This configuration also has the advantage of reducing the overall dimensions of the balances (surface). According to one embodiment, the dimensions of the two inertia wheels are substantially identical. These two inertia wheels define two discs with an overlapping zone 29a resembling a symmetrical lens, as illustrated in FIG. 28. According to another embodiment illustrated in FIG. 29, the diameter D1 of one of the inertia wheels 24a, 24b is smaller than the diameter D2 of the other of the inertia wheels. For example, the first diameter DI is less than 80% of the second diameter D2. In this case, the overlapping zone 29b resembles an asymmetrical lens.

When the regulating member 20 is in operation, the oscillations of the inertia wheels 24a, 24b of the hairspring-balances 22a, 22b are synchronised in phase opposition so that the rim segments 28a of the inertia wheel 24a of one of the two hairspring-balances 22a, 22b never come into contact with the rim segments 28b of the inertia wheel 24b of the other of the two hairspring-balances 22a, 22b.

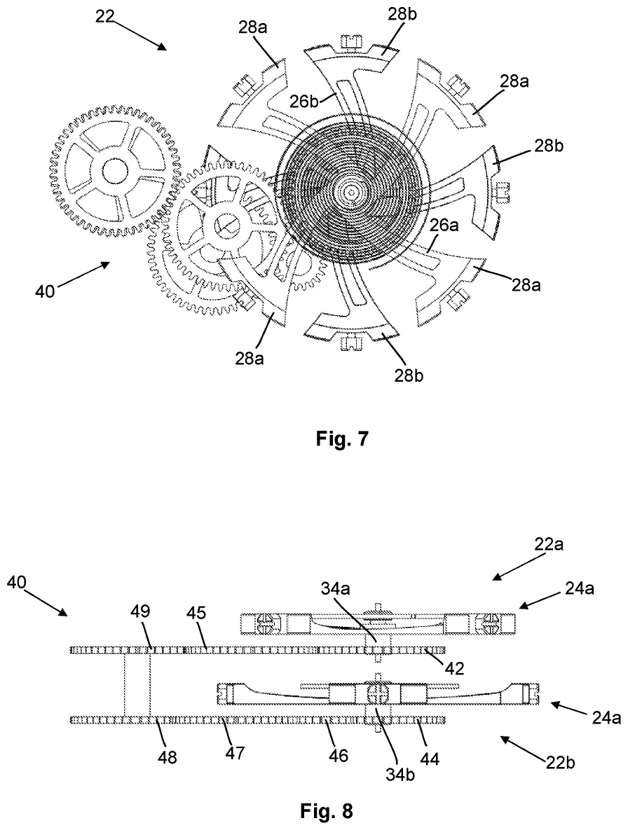

According to another embodiment illustrated by FIGS. 6 to 8, the oscillator 22 comprises a first and a second hairspring-balance 22a, 22b mounted coaxially. The first and second hairspring-balances 22a, 22b are connected together by a gear train 40 so that the inertia wheel 24a of one of the two hairspring-balances 22a, 22b can oscillate in phase opposition with respect to the inertia wheel 24b of the other of the two hairspring-balances to cancel out or, at least, reduce the sensitivity of the oscillator 22 to angular accelerations. According to another non-illustrated embodiment, the first and second hairspring-balances are arranged so that their respective inertia wheel oscillates in two parallel planes with their respective balance staff parallel to each other.

According to FIG. 8, the gear train 40 comprises a first mobile 42 connected to the balance staff 34a of the first hairspring-balance 22a, a second mobile 44 connected to the balance staff 34b of the second hairspring-balance 22b, and an intermediate gear train. The intermediate gear comprises a third mobile 45 in mesh with the first mobile 42, a fourth mobile 46 in mesh with the second mobile 44, a fifth mobile 47 in mesh with the fourth mobile 45 as well as a lower mobile 48 and an upper mobile 49 mounted coaxially so that the lower and upper mobiles 48, 49 are in mesh respectively with the fifth mobile 47 and the third mobile 45.

As in the first embodiment, the inertia wheel 24a, 24b of each hairspring-balance 22a, 22b comprises four arms 26a, 26b separated from each other by an angle of 90° and having the same characteristics as the arms of the two hairspring-balances of the regulating member illustrated in particular in FIG. 2. The number of arms may be other than four. Each inertia wheel 24a, 24b may, for example, comprise only two or three arms as previously mentioned.

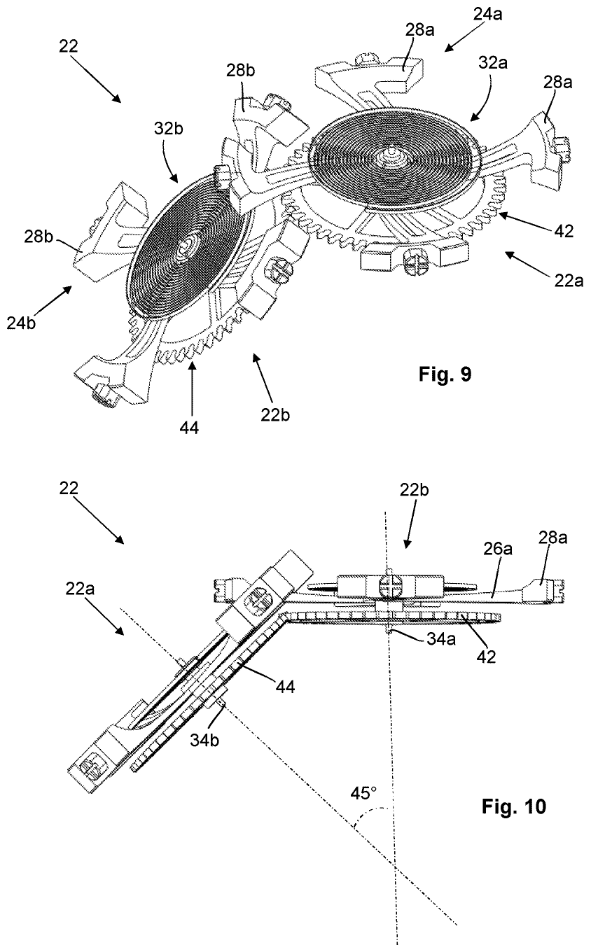

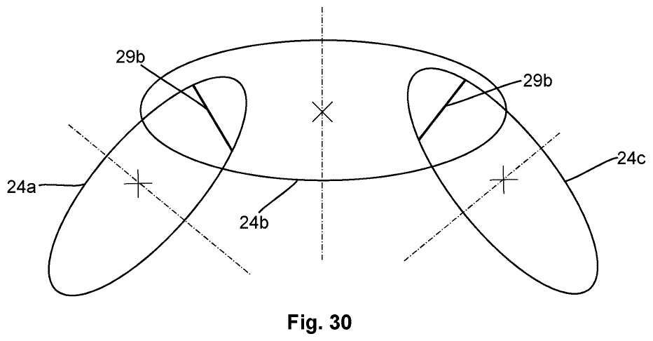

According to another embodiment illustrated by FIGS. 9 and 10, the oscillator 22 comprises a first and a second hairspring-balance 22a, 22b mounted so that their respective balance staffs are concurrent. For example, the first and second balance staffs form an angle between them substantially equal to 45° according to FIG. 10, although this angle may vary substantially according to alternative embodiments, for example between 30° and 60°. According to one embodiment, illustrated in FIG. 30, the oscillator comprises three balances, each comprising an inertia wheel 24a, 24b and 24c, each defining a disc. The balances are arranged so that a first and a second disc intersect a third disc along a first and a second intersection zone 29a which are rectilinear.

The advantage of this embodiment lies in particular in the simplified gear train so that the inertia wheels 24a, 24b of the first and second hairspring-balances 22a, 22b respectively can oscillate in phase opposition, since this gear train comprises only two mobiles 42, 44 with appropriate teeth, conical for example, in direct mesh.

As for the first and second embodiments, the inertia wheel 24a, 24b of each hairspring-balance comprises four arms 26a, 26b separated from each other by an angle of 90° and having the same characteristics as the arms of the two hairspring-balances of the regulating member illustrated in particular in FIG. 2. Each hairspring-balance 24a, 24b may comprise only two or three arms according to an alternative embodiment as already mentioned above.

As in the first embodiment, when the oscillator 22 is operating, the oscillations of the inertia wheel 24a of one of the two hairspring-balances 22a, 22b are synchronised in phase opposition with respect to the oscillations of the inertia wheel 24b of the other of the two hairspring-balances 22a, 22b so that the rim segments 28a, 28b of the respective inertia wheels 24a, 24b never come into contact.

The regulating member 20 according to the invention can be implemented in different configurations of the oscillator and escapement according to the schematic FIGS. 11 to 24 in order to transmit the oscillation frequency of the regulating member 20 to the kinematic link connecting the barrel 14 to the pinion of the escapement wheel 16, preferably via a single mobile 19 according to the schematic representation of FIG. 1. The escapement may comprise one or more anchors, for example of the Swiss anchor type. Alternatively, the escapement may comprise any other device acting between the oscillator and an escapement wheel, for example a detent or coaxial escapement. The term “anchor” is therefore to be taken in the present application in the broad sense, designating any member intended to cooperate between the regulating member and the escapement wheel(s).

According to the embodiment shown in FIG. 11, the regulating member 20 comprises an oscillator 22 comprising two hairspring-balances 22a, 22b, for example the oscillator 22 shown in FIG. 2. The first and second inertia wheels 24a, 24b are arranged to oscillate in phase opposition. The escapement has a single escapement anchor 17, for example a Swiss anchor.

The anchor 17 comprises an entry pallet 170 and an exit pallet 172 arranged to cooperate with the escapement wheel 16 in a conventional manner in order to transmit the oscillations of the inertia wheel 24a of a single hairspring-balance 22a of the regulating member 20 to the escapement wheel 16 so that the rotation of the escapement wheel 16 occurs at the rate of the oscillations of the inertia wheel 24a. To this end, the anchor 17 comprises a fork 179 arranged to cooperate with an impulse pin of the balance staff.

The inertia wheel 24a of one of the hairspring-balances is connected to the inertia wheel 24b of the other of the hairspring-balances by a gear train with an even number of gears 42, 44, 46, 48 so as to reverse the direction of rotation of the balances.

Each hairspring-balance 22a, 22b comprises a hairspring 32a, 32b wound in the same direction in such a way that during running of the movement, the hairspring of one of the hairspring-balances is in a contraction phase while the hairspring of the other of the hairspring-balances is in an expansion phase, i.e. in phase opposition.

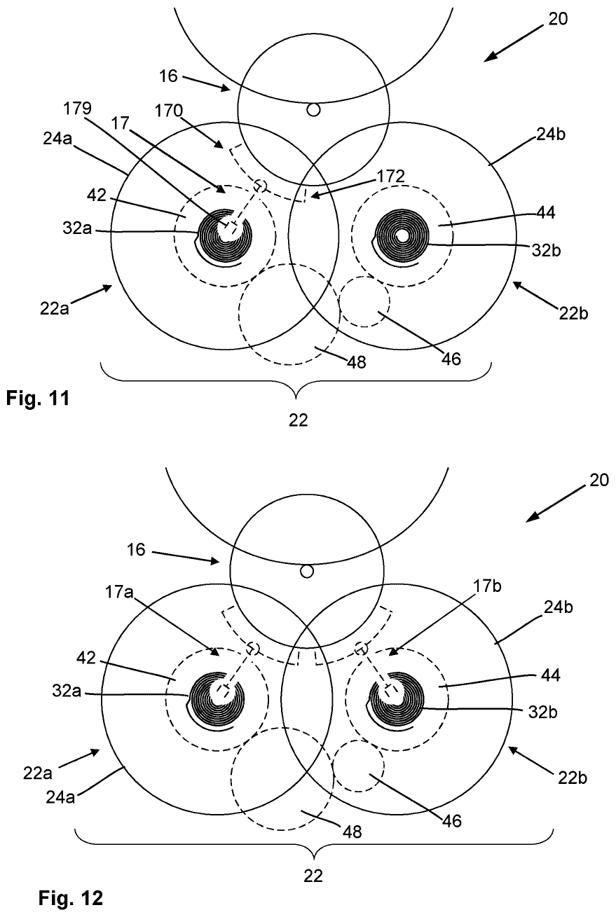

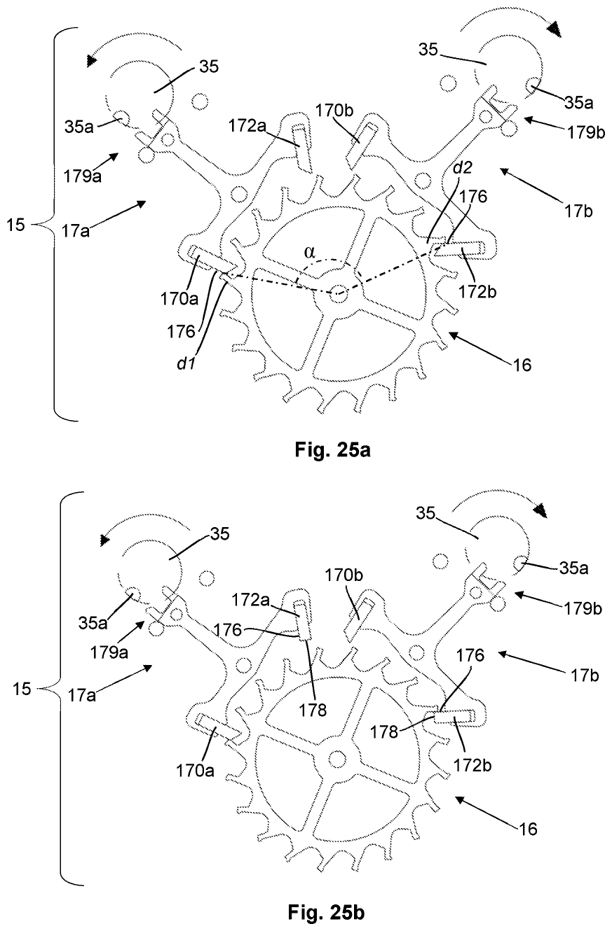

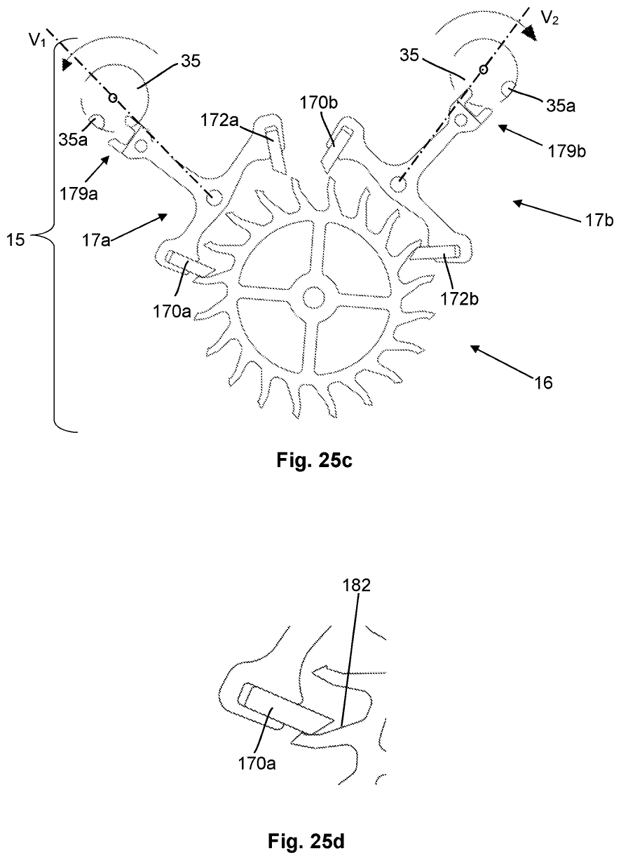

According to FIG. 12 and with reference to the different embodiments illustrated by FIGS. 25a-25d, the regulating member 20 has an architecture comparable to that of FIG. 11, with the difference that the first and second hairspring-balances 22a, 22b cooperate respectively with a first and a second anchor 17a, 17b, which cooperate with a same escapement wheel 16.

In particular, with reference in particular to FIG. 25a, the first escapement anchor 17a comprises an input pallet 170a and an output pallet 172a arranged to cooperate with the teeth of the escape wheel 16, whereas the second escapement anchor 17b comprises an input pallet 170b and an output pallet 172b arranged to cooperate with the teeth of the escapement wheel 16 alternately with the first escapement anchor 17a. The first and second escapement anchors 17a, 17b are arranged so that the entry and exit pallets of each anchor can cooperate with different teeth.

According to this arrangement, the exit pallet 172a of the first escapement anchor 17a is arranged facing the entry pallet 170b of the second escapement anchor 17b, while the entry pallet 170a of the first escapement anchor and the exit pallet 172b of the second escapement anchor 17b are spaced apart so as to cooperate with teeth of the escapement wheel 16 which are separated by an angle of less than 180° when passing through the center of the wheel 16. To this end, the escapement wheel 16 has at least 20 teeth, while a fork 179a, 179b of each anchor is arranged to cooperate with the impulse pin 35a of the roller 35 of the balance staff of the corresponding hairspring-balance 22a, 22b. An escapement wheel with less than 20 teeth, for example 15 teeth, may also be used under certain conditions.

As a result of the opposite directions of rotation of the inertia wheels 24a, 24b (FIG. 12) as previously described, the anchors 17a, 17b work symmetrically. FIG. 25a shows one tooth of the escapement wheel 16 on the rest plane 176 of the entry pallet 170a of the first anchor 17a and another tooth of the escapement wheel 16 on the rest plane 176 of the exit pallet 172b of the second anchor 17b. The angle α defined by the points of contact between the respective rest planes 176 of the entry pallet 170a and the exit pallet 172b respectively of the first and second anchors 17a, 17b with respectively a first and a second tooth of the escapement wheel 16 and by the center of the escapement wheel 16 is less than 180° and is preferably between 130° and 160°. The operating principle of the escapement 15 in FIG. 25a requires the settings to be made in such a way that the operating phases of the anchors take place simultaneously.

According to the embodiment illustrated in FIG. 25b, the impulse plane of the exit pallet 172a of the first anchor 17a and the impulse plane of the exit pallet 172b of the second anchor 17b are eliminated so that the distal part of the exit pallets 172a, 172b of the first and second anchors 17a, 17b forms an angle of approximately 90° with the rest plane 176 of the pallet.

This specific shape of the distal part of the aforementioned pallets has the advantage of avoiding the constraint imposed by the operating phases of the first and second anchors, which must be performed simultaneously according to the embodiment illustrated in FIG. 25a. This simplifies the setting of the escapement 15. However, the pallets are sized so that the drawing function is fulfilled.

The dimensions of the pallets are such that the teeth of the escapement wheel bear well on the rest planes of the truncated pallets so as to ensure that the anchor is locked in the conventional way and that the release phase on this pallet is no longer than on the non-truncated pallet of the other anchor so as to avoid a loss of energy during the impulse. This form of construction has the advantage of facilitating the auto-start of the escapement 15.

According to the embodiment illustrated in FIG. 25c, the escapement adopts the operating principle described in EP2923242A1, the content of which is incorporated by reference in the present application, so as to avoid the hyperstatism of the escapement 15 according to FIG. 25a and the residual sensitivity of adjustment of the escapement according to FIG. 25b. In the present case, in order to obtain correct operation of the escapement, the tooth bearing on the entry or exit pallets must be positioned very precisely with respect to the end of the rest plane of the pallets so that the release and impulse phases of the escapement operate correctly.

Considering the manufacturing tolerances, an escapement with a conventional anchor generally requires a final adjustment of the positions of the entry and exit pallets. This adjustment is generally long and delicate because it can have a significant influence on the efficiency of the escapement.

The escapement 15 of FIG. 25c is similar to the escapement of FIG. 25a in the arrangement of first and second anchors 17a, 17b arranged to cooperate with an escapement wheel 16. The escapement wheel differs, however, in the profile of its teeth.

In the present case, each tooth of the escapement wheel 16 has a driving plane 182 (FIG. 25d) oriented so that contact between the entry pallet 170a, 170b and the exit pallet 172a, 172b of each anchor 17a, 17b and the escapement wheel via the driving plane 182 creates a torque which tends to reduce the angle between the anchor and the reference axis V1, V2 connecting the axes of the anchor and the balance for each of the first and second anchors 17a, 17b. In other words, the present implementation provides a driving plane that causes the anchor to naturally arrive at an equilibrium position, as the driving plane is arranged to create a torque creating movement towards the equilibrium position.

According to a non-illustrated embodiment, the driving plane may be located on one of the pallets of the first and second anchors, while the escapement wheel comprises conventional teeth.

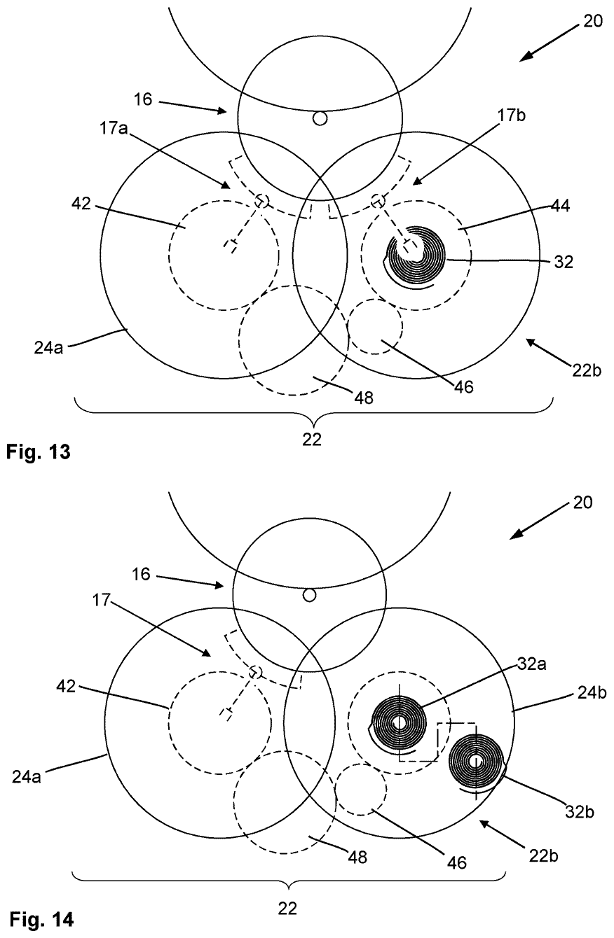

The regulating member 20 according to the embodiment of FIG. 13 has an architecture comparable to that of FIG. 12, with the difference that one of the balances does not have a hairspring. This balance has an inertia wheel 24 connected to the first mobile 42. The latter meshes with a gear train comprising two intermediate mobiles 46, 48 and the second mobile 44 connected to the hairspring-balance 22b. The inertia wheel 24a is thus driven by a desmodromic linkage to oscillate in tune with the oscillations of the hairspring-balance 22b, but in the opposite direction. The hairspring-balance 22b may comprise a single hairspring or, in a variant not illustrated but similar to FIG. 14, a pair of hairsprings wound in opposite directions to obtain a phase opposition.

According to the embodiment of FIG. 14, only one of the balances of the oscillator 22 is arranged to cooperate with the escapement wheel 16. This balance has no hairspring and its inertia wheel 24a is connected to the first mobile 42. As with the regulating member of FIG. 13, the first mobile 42 is in mesh with a gear train comprising two intermediate mobiles 46, 48 and the second mobile 44 connected to the hairspring-balance 22b. The inertia wheel 24a is thus driven by a desmodromic link to oscillate at the rate of the oscillations of the hairspring-balance 22b but in the opposite direction. The hairspring-balance 22b comprises for its part a single hairspring or preferably two hairsprings 32a, 32b mounted coaxially and wound in opposite directions to obtain a phase opposition.

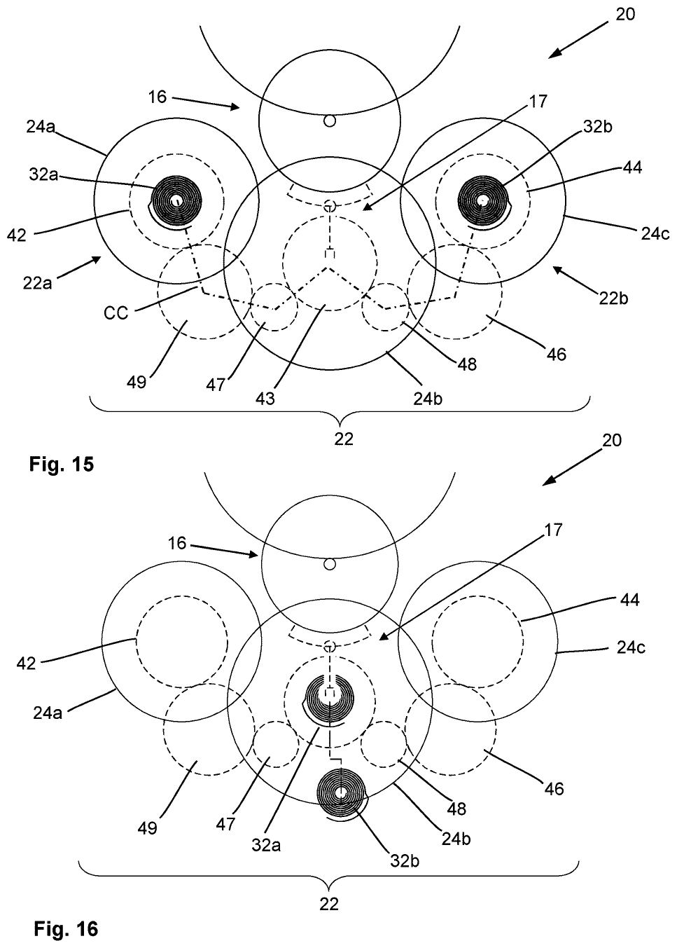

According to the embodiment of FIG. 15, the oscillator 22 of the regulating member 20 comprises three balances, namely two hairspring-balances 22a, 22b and one balance without hairspring. The latter has an inertia wheel 24c connected to a mobile 43 of the gear train and is arranged to cooperate with the escapement wheel 16 via an anchor 17. The two hairspring-balances 22a, 22b are arranged at the end of the kinematic chain CC of the desmodromic link of the oscillator 22 on either side of the balance without hairspring. In the example shown, the inertia wheels 24a, 24b rotate in the same direction thanks to the odd number of mobiles 43, 46, 47, 48, 49 of the gear train linking the two hairspring-balances 24a, 24b. The hairspring 32a of the hairspring-balance 22a is therefore wound in the opposite direction to the hairspring 32b of the hairspring-balance 22b to obtain a phase opposition. In general, the respective oscillations of two successive balances in the kinematic chain CC of a regulating member comprising at least three balances are in phase opposition.

According to the embodiment of FIG. 16, the oscillator 22 of the regulating member 20 also comprises three balances, namely a central hairspring-balance 22c arranged to cooperate with the escapement wheel 16 and two balances without hairsprings and which are arranged on either side of the central hairspring-balance. The latter comprises two hairsprings 32a, 34 mounted coaxially and wound in opposite directions to obtain a phase opposition. In a variant not shown, the central hairspring-balance may have only one hairspring. The oscillations of the inertia wheels 24a, 24b located on either side of the central hairspring-balance 22c occur at the rate of the oscillations of the latter by the gear train.

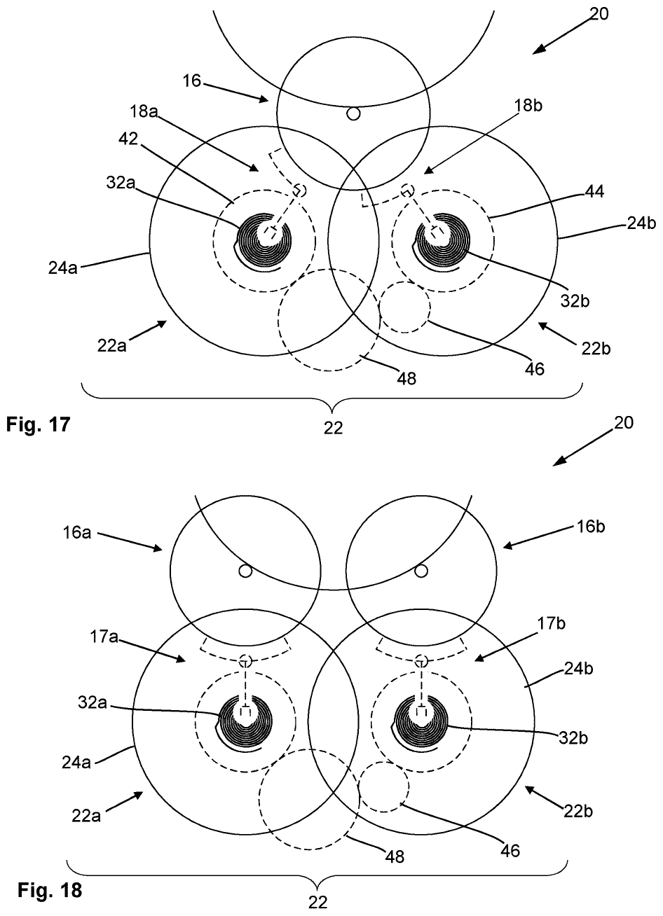

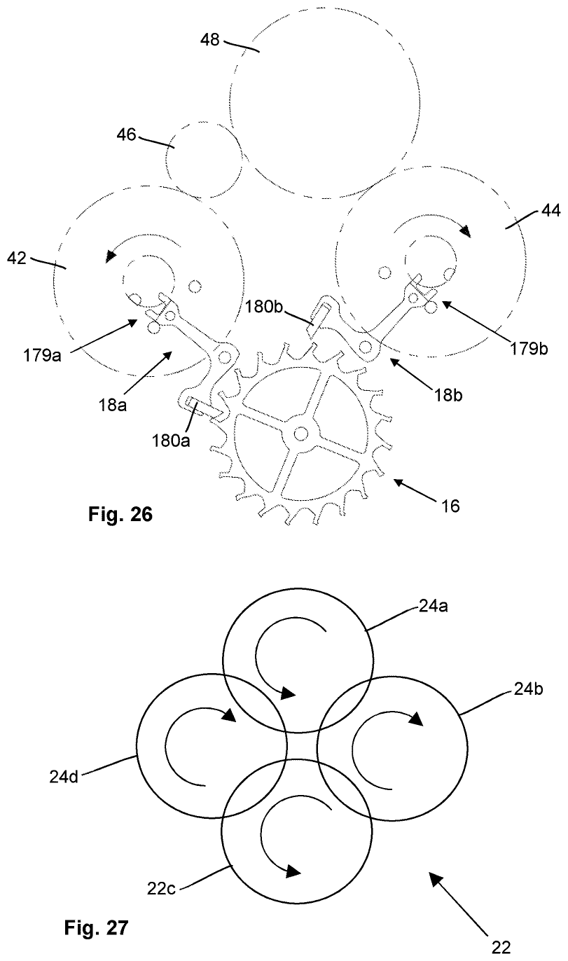

According to the embodiment of FIG. 17 and with reference to FIG. 26, the first and second hairspring-balances 22a, 22a of the regulating member 20 cooperate respectively with a first and a second escapement half-anchor 18a, 18b which cooperate with the same escapement wheel 16. In this case, the first half-anchor 18a comprises an entry pallet 180a while the second half-anchor 18b comprises an exit pallet 180b. The operation of the escapement 15 is thus decoupled by creating two half-anchors, each working with the impulse pin of a balance staff. In this case, the impulsions are distributed between the first and second hairspring-balances 22a, 22b of the oscillator 22. The hairsprings 32a, 32b of the respective hairspring-balances 22a, 22b are wound in the same direction in order to obtain a phase opposition. According to a non-illustrated variant, one of the balances has no hairspring, while the other balance has a pair of hairsprings mounted in phase opposition.

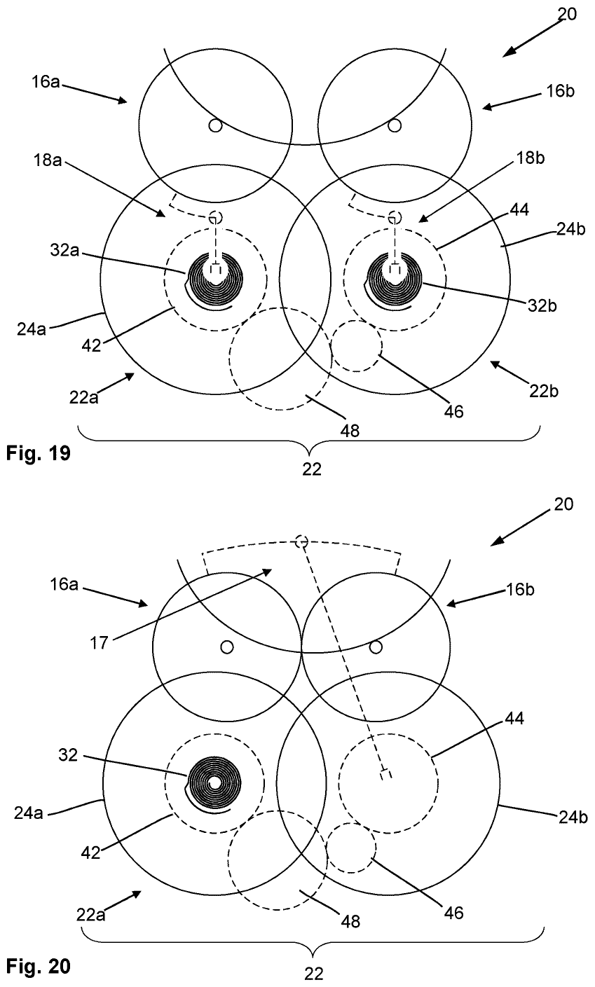

According to the embodiments of FIGS. 18 and 19, the regulating member 20 comprises an architecture comparable to that of FIG. 17 with the difference that the first and second hairspring-balances 22a, 22b cooperate respectively with a first and a second escapement wheel 16a, 16b via a first and a second anchor 17a, 17b according to the regulating member 20 of FIG. 18 or via a first and a second half-anchor 18a, 18b according to the regulating member of FIG. 19. The hairsprings 32a, 32b of the respective hairspring-balances 22a, 22a are also wound in the same direction in order to obtain a phase opposition. According to a non-illustrated variant, one of the balances does not have a hairspring, while the other balance has a pair of hairsprings mounted in phase opposition.

According to the embodiment of FIG. 20, the oscillator 22 of the regulating member 20 comprises a hairspring-balance 22a and a balance without a hairspring. The regulating member comprises an escapement including, on the one hand, a first and a second escapement wheel 16a, 16b arranged to be driven in opposite rotation to each other, and on the other hand, an anchor 17 arranged to cooperate with one of the balances, for example the one without a hairspring, and with the two escapement wheels. The hairspring-balance 22a preferably comprises two hairsprings mounted in phase opposition. In a non-illustrated variant, each balance comprises a hairspring.

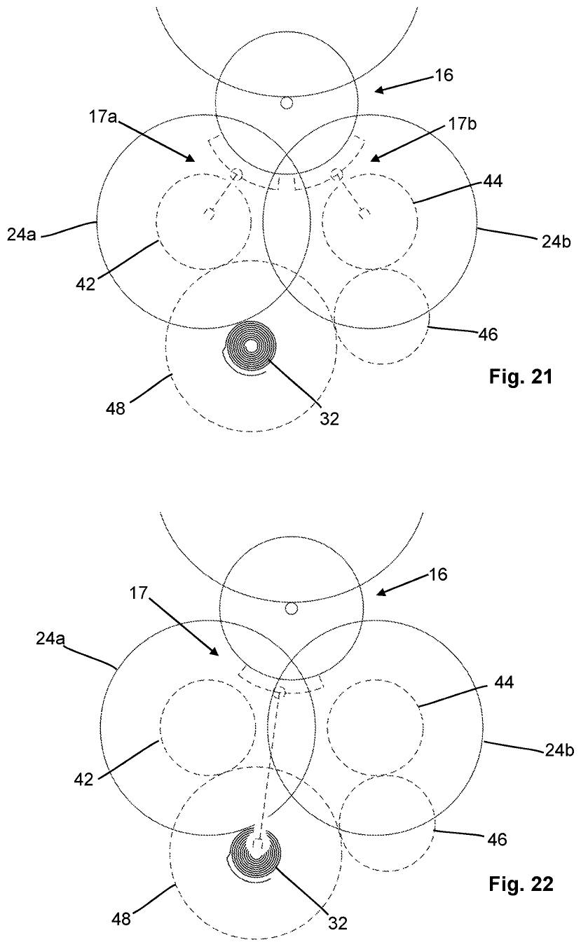

Two other embodiments of the regulating member are illustrated in FIGS. 21 and 22. The first and second balances of the oscillator 22 are mounted in phase opposition and have no hairspring. These balances therefore comprise only an inertia wheel 24a, 24b. The hairspring 32 is mounted on a mobile 48 of the gear train of the oscillator 22. Centering the hairspring in the gear train has the advantage of reducing return effects compared with a hairspring at one end of the oscillator chain. The inertia wheels 24a, 24b are therefore preferably without a hairspring. According to this embodiment, the inertia of the mobile 48 is at least five times, preferably at least ten times, or even at least twenty times less than the inertia of any of the balances.

With reference to FIG. 22, the gear train is arranged to impart a reciprocating movement to the mobile 48, which cooperates with the anchor 17 by means, for example, of a pin (not illustrated) connected to the mobile 48.

The mobile 48 can be larger or smaller than the mobiles 42, 44 connected respectively to the first and second balances 22a, 22b, so as to increase the dimensioning range of the hairspring-balance coupling and of the amplitudes (the amplitude of the hairspring-mobile can be adapted to the ideal operation of the escapement, while the amplitude of the balances can be adapted to their inertia). According to the regulating member of FIG. 22, the pitch diameter of the mobile 48 is greater than the pitch diameter of the respective mobiles 42, 44 of the first and second balances 22a, 22b.

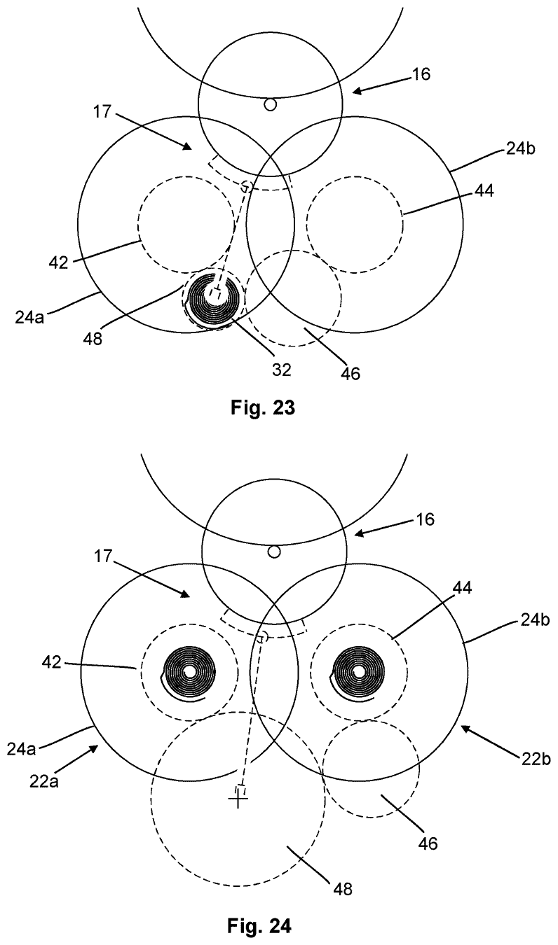

Another example of a regulating member is schematically illustrated in FIG. 23. This regulating member is similar to the regulating member of FIG. 22, with the difference that the hairspring 32 is mounted on a mobile 48 of the gear train, the pitch diameter of which is smaller than the pitch diameter of the respective mobiles 42, 44 of the first and second balances 24a, 24b.

According to another embodiment schematically illustrated in FIG. 24, the regulating member comprises two hairspring-balances 22a, 22b mounted in phase opposition, while the mobile 48 of the gear train is arranged to cooperate with the anchor 17 by means, for example, of a pin (not illustrated) connected to the mobile 48. The latter is animated by a reciprocating movement when the regulating member is in operation in order to regulate the rotation of the escapement wheel 16 and to maintain the oscillations of the first and second balances.

According to the embodiments illustrated by FIGS. 12, 13 and 21, the escapement wheel 16 can be replaced by two coaxial escapement wheels which can be connected to each other or movable relative to each other, in particular for play compensation and/or to optimize contact with the pallets.

According to another embodiment schematically illustrated in FIG. 27, the oscillator of the regulating member comprises four inertia wheels 24a, 24b, 24c, 24d. Each inertia wheel 24a, 24b, 24c, 24d resembles the inertia wheels of the regulating member according to the embodiment illustrated in particular in FIGS. 2 to 4. The distal parts of each inertia wheel form together several disjoint rim segments, for example three or four segments, along a first, a second, a third and a fourth circle respectively. The center-to-center distance between the four balance staffs is reduced so that each circle intersects another of the four circles. The four inertia wheels 24a, 24b 24c, 24d are interconnected by a gear train (not illustrated) adapted so that two inertia wheels 24a, 24c oscillate in the same phase and in phase opposition with respect to the other two inertia wheel 24b, 24d. The four inertia wheels 24a, 24b, 24c, 24d are preferably arranged to oscillate in the same plane.

The regulating member according to the invention makes it possible to involve several mobile of a gear train between the balance, the hairspring and the escapement wheel, which are directly linked together in a conventional regulating member. The dimensioning of each mobile determines their respective couplings. This dimensioning enables the implementation of new adjustment methods between:
the return torque of the at least one hairspring and the inertia of the balances, while maintaining unchanged the power required to maintain the oscillations of the oscillator,
the power required to regulate the oscillator and the power delivered by the at least one escapement wheel.

These adjustment methods may in particular have the advantage of making it possible to compensate for:
variations in the mass production of components (distribution of hairspring torques or inertia of balances in production batches),
variations in the torque supplied by the driving organ of a movement equipped with such a regulating member,
variations caused by the consumption of additional functions of mechanisms in a movement equipped with such a regulating member (the same basic movement can power several calibers whose additional functions vary, but for which the same regulating member would be used, its power being adapted according to the consumption of these additional functions).

Adjustment using these methods may be complementary to other conventional adjustments, in particular adjustment using screws or eccentrics mounted on balances or adjustment using the index assembly.

It is possible, by modifying the geometric properties (pitch diameter and/or inertia) of mobiles of the gear train, in particular of at least one of the mobiles 42, 43, 44, 45, 46, 47, 48, 49 of the gear train 40, to modify the pairing between the return torque of the at least one hairspring and the inertia of the balances while maintaining unchanged the power required to maintain the oscillations of the oscillator.

The method therefore comprises the following steps:
determining the inertia of all the balances of the oscillator,
determining the return torque of the elastic member of the oscillator,
comparing these values with the theoretical values giving the target performance and determining the modification to be made to achieve it, whether this involves a mobile with a larger/lower inertia or a mobile with a larger/smaller nominal diameter,
replacing the initial mobile(s) with the mobile(s) determined in the previous step,
optionally, measuring the chronometric performance of the regulating member, and
optionally starting again if the pairing still needs to be improved/refined.

Although the inertia of the mobiles of the gear train is very much lower than that of the balances (the mobiles not having sufficient inertia to enable them to maintain oscillations, i.e. they cannot be assimilated to balances), a variation of this inertia can nevertheless modulate in small proportions the relationship between the inertia of the hairspring-balance and the return torque of the hairspring and modify the period of the oscillations, and therefore the running of the watch movement equipped with such a regulating member.

The inertia of a mobile of the gear train can be modified in various ways, in particular by 1) changing the material to achieve different densities and therefore different inertias for the same dimensions, by 2) changing the thickness and therefore different inertias for the same pitch diameter (or contour profile), or by 3) changing the effective mass for the same external dimensions, using apertured mobiles.

By modifying the pitch diameter of one of the mobiles, in particular a mobile carrying a hairspring, the ratio between the inertia and the return torque of the hairspring is modified. Changing the pitch diameter of a gear generally involves changing the number of teeth for the same module. There are, however, other means of fine modulation such as offsets, which consist of modifying the pitch diameter with the same number of teeth and thus the relationship between mobiles meshing together.

As the energy available to the escapement wheel can vary upstream (in particular due to the torque developed by the barrel spring, which can vary during production, but also in more specific cases such as additional openings on mobiles—skeletons, or even in the case of driving additional modules with different consumption levels), it is also possible to modify these pairings to adapt the characteristics of the regulating member to the quantity of energy available to the escapement wheel.

This involves the following steps:
determining the torque supplied by the driving source to one or more escapement wheels,
determining the effective inertia of the balances equipping the regulating member,
determining the return torque of the elastic member equipping the regulating member,
comparing these values with the theoretical values giving the targeted performances and determining the modification to be made to achieve them, a modification of the inertia of a wheel being able to be accompanied by a modification of the nominal diameter of the same mobile or of another mobile of the gear train, this in order to preserve the equilibrium hairspring-balance,
replacing the initial mobile(s) with mobiles determined in the previous step,
optionally measuring the chronometric performance of the regulating member, and
optionally starting again if the pairing still needs to be improved/refined.

In order to optimize the adjustment process described above, it may be useful to carry out statistical determinations (if it is only a question of compensating for serial distributions) or needs determinations (if it is a question of compensating for variations in consumption of additional functions) in order to divide the pairing mobiles into classes, and to size these classes (gaps) as a function of the aforementioned needs.

Finally, if mobiles of different pitch diameters are to be used, it is obvious that the positioning of the mobiles in their support (escapement holder, cock plate or other), guiding means (bearing, ball bearings, etc.) will have to be configured so that their relative spacing can be adapted to the variations in center distance resulting from the pairing. These means for adjusting the center distances are well known in the prior art, as disclosed for example in CH131854.

In particular, the guide means may be mounted on intermediate supports allowing this adjustment, but other means are also conceivable without departing from the scope of the invention.

### REFERENCE LIST

Watch movement 10
Plate 12
Barel 14
Escapement 15
   Escapement wheel 16, 16a, 16b
   Transmission member
      Escapement anchor 17a, 17b
         Entry and exit pallets 170, 172; 170a, 172a; 170b, 172b
         Impulse plane 174
         Rest plane 176
         Distal part 178
         Driving plane 182
         Fork 179
      First half-anchor 18a
         Entry pallet 180a
      Second half-anchor 18b
         Exit pallet 180b
Regulating member 20
   Oscillator 22
   Hairspring-balance 22a, 22b
      Inertia wheel 24a, 24b, 24c, 24d
         First and second circles 25a, 25b
         Balance arm 26a, 26b
         Rim segments 28a, 28b
         Intersecting zone 29a, 29b
         Weights 30a, 30b
      Hairspring 32, 32a, 32b
      Balance staff 34a, 34b
         Roller 35
         Impulse pin 35a
      Collet 36a, 36b
         Gear train 40
         First mobile 42
      Second mobile 44
      Intermediate mobiles 45, 46, 47, 48, 49
   Kinematic chain CC
Second indicator 50
Minute indicator 52
Hour indicator 54

1. Regulating member for a watch movement, comprising an oscillator including at least a first and a second balance each comprising an inertia wheel and a balance staff, the oscillator comprising at least one elastic member intended to maintain the oscillations of the oscillator, said oscillator further comprising a gear train comprising at least two mobiles, the inertia wheel of each balance being fixed in rotation to a mobile of the gear train, said gear train being arranged to connect together the inertia wheels of the first and second balances by a desmodromic link so that the respective oscillations of the first and second balances are in phase opposition, the regulating member further comprising an escapement comprising at least one escapement wheel and at least one anchor intended to regulate said at least one escapement wheel and to maintain the oscillations of said oscillator.

2. Regulating member of claim 1, comprising at least three balances, each comprising an inertia wheel, the respective oscillations of two balances following each other in the kinematic chain of said at least three balances being in phase opposition.

3. Regulating member of claim 1, wherein said gear train comprises more than two mobiles.

4. Regulating member of claim 1, wherein the balance staffs of the first and second balances are coaxial.

5. Regulating member of claim 1, wherein the balance staffs of the first and second balances are parallel while their respective inertia wheels are arranged to oscillate in two parallel planes.

6. Regulating member of claim 1, wherein the inertia wheels of the first and second balances are substantially comprised in the same plane.

7. Regulating member of claim 1, wherein the balance staffs of the first and second balances are comprised in intersecting planes.

8. Regulating member of claim 6, wherein the inertia wheel of each of the first and second balances comprises a plurality of disjoint rim segments), for example two, three or even four rim segments, forming together the rim of each inertia wheel along respective circles defining respectively a first and a second disc intersecting or overlapping so as to form an overlapping zone or an intersecting zone.

9. Regulating member of claim 8, wherein said overlapping zone has the shape of a lens, said lens preferably being a symmetrical lens.

10. Regulating member of claim 8, wherein said intersecting zone is a straight-line segment.

11. Regulating member of claim 1, wherein at least one of the first and second balances does not comprise said at least one elastic member.

12. Regulating member of claim 1, wherein said at least one elastic member is mounted on an intermediate mobile of said gear train, the inertia of said intermediate mobile being at least five times, preferably at least ten times, or even at least twenty times less than the inertia of any of said balances.

13. Regulating member of claim 1, in which at least one of the first and second balances and/or an intermediate mobile of the gear train comprises an even number, preferably two, of elastic members wound in opposite directions.

14. Regulating member of claim 1, wherein the escapement comprises only one anchor arranged to cooperate with one of the first and second balances and the escapement wheel.

15. Regulating member claim 1, wherein the escapement comprises two anchors arranged to cooperate, on the one hand, with the first and second balances respectively and, on the other hand, with a single escapement wheel, or with a first and second escapement wheel respectively.

16. Regulating device according to claim 1, wherein the escapement comprises a first and a second half-anchor arranged to cooperate respectively with the first and second balances, the first and second half-anchors comprising respectively a first pallet and a second pallet arranged to cooperate with a single escapement wheel or respectively with a first and a second escapement wheel.

17. Regulating device of claim 1, wherein the escapement comprises an anchor arranged to cooperate with one of the first and second balances, the anchor comprising a first pallet arranged to cooperate with a first escapement wheel and a second pallet arranged to cooperate with a second escapement wheel.

18. Regulating device of claim 1, wherein the escapement comprises an anchor arranged to cooperate with an intermediate mobile of the gear train and an escapement wheel.

19. Method for adjusting the frequency of the oscillator of the regulating member of claim 1, wherein one determines the inertia of all the balances of the oscillator and the return torque of said at least one elastic member of the oscillator, then one replaces at least one of the mobiles of said gear train, preferably an intermediate mobile, by a mobile of different inertia so as to obtain a ratio between the inertia of all the balances and the return torque of said at least one elastic member defined by the desired frequency of the oscillator.

20. Method of adjusting the frequency of the oscillator of the regulating member of claim 1, wherein one determines the inertia of all the balances of the oscillator and the return torque of said at least one elastic member, then one replaces at least one of the mobiles of said gear train, preferably an intermediate mobile, by a mobile with a pitch diameter different from the replaced mobile so as to obtain a ratio between the inertia of all the balances of the oscillator and the return torque of said at least one elastic member defined by the desired frequency of the oscillator.

21. Method of setting a watch movement comprising a driving source, in particular a barrel, and the regulating member of claim 1, wherein one determines the torque supplied by said driving source to said escapement wheel, the inertia of all the balances and the return torque of said at least one elastic member, and then one replaces at least one mobile of said gear train, preferably an intermediate mobile by a mobile with a different inertia and/or a different pitch diameter so as to obtain a defined ratio between the inertia of all the balances and the return torque of said at least one elastic member and a defined ratio between the power for maintaining the oscillations of the oscillator and the power available to the escapement wheel.
